(19) United States
(12) Patent Application Publication
(10) Pub. No.: US 2011/0200269 A1
(43) Pub. Date: Aug. 18, 2011

(54) Fast Approximation For Bilateral Filter

(76) Inventors: Mithun Das Gupta, Cupertino, CA (US); Jing Xiao, Cupertino, CA (US)

(21) Appl. No.: 12/707,903

(22) Filed: Feb. 18, 2010

(51) Int. Cl. G06K 9/40; G06F 17/14

(52) U.S. Cl. 382/260; 708/300; 708/400

(57) ABSTRACT

Multiple filters of a bilateral filter are decoupled to form into multple linear filtering operations, which permits faster processing. The bilateral filter is re-presented as an approximate bilateral filter, and subjected to a logarithm whose resultant components are further subjected to a series of Jensen approximations. The errors resulting from each Jensen approximation are collected into a single cumulative error factor, and it is then shown that the cumulative error may be ignored without adversed affect to the result. Thus, the original bilateral filter may be implemented as log(y₀)=log(2−ΣgⱼKⱼ)+log(ΣKⱼfⱼ)+log(ΣKⱼgⱼ).

### BACKGROUND

1. Field of Invention

The present invention is related to the field of bilateral filters. More specifically, it is related to the field of approximate bilateral filters.

2. Description of Related Art

Bilateral filtering is a non-linear filtering technique that can combine image information from two domains. Typically, bilateral filtering combines the space domain with a feature domain in the filtering process. Thus, a bilateral filter combines information from the spatial domain and information from a feature domain. A bilateral filter can be represented as

$$y ( i ) = \frac{1}{Z ( i )} {\sum }_{j ∈ {Ω}_{i}} I ( j ) K ( i , j ) g ( I ( i ) , I ( j ) ) \qquad ( 1 )$$

where I and y are the input and output images respectively, i is the target pixel and j is a pixel in the symmetric neighborhood of i denoted by Ωᵢ. K(i, j) relates to the spatial domain and measures the spatial affinity between pixels at i and j. In essence, K(i, j) may be thought of as a spatial filter component. Similarly, g(I(i), I(j)) relates to a feature domain and denotes the feature/measurement/photometric affinity, an may be thought of as a feature filter component. Z(i) is the normalization factor at i.

For example in image editing, a bilateral filter may be used as an edge-preserving smoothing filter. Whereas other filters generally are convolutions in solely the image domain, the bilateral filter can also operate on the image's range domain, i.e. pixel values. Rather than simply replacing a pixel's value with a weighted average of its neighbors, as is the case for a a Gaussian filter, the bilateral filter can replace a pixel's value by a weighted average of its neighbors in both space and range (pixel value). This can preserve sharp edges by systematically excluding pixels across discontinuities from consideration.

A disadvantage of bilateral filters, however, is that since they require the merging of multiple filters, they tend to be more resource intensive and require longer to process. The approximate bilateral filter, ABLF, has been developed to decrease the processing time at the expense of an introduction of some error that typically must be dealt with separately.

It is an object of the present invention to provide a fast approximate bilateral filter, FABL Filter, that permits even greater gains in processing speed.

It is a further object of the present invention to provide a fast approximate bilateral filter whose introduced error may be completely ignored without adverse effect to the end-result image.

### SUMMARY OF INVENTION

The present objects have been met in a method for implementing a bilateral filter, including: providing a data processing device to implement the following steps: defining said bilateral filter as

$$y ( i ) = \frac{1}{Z ( i )} {\sum }_{j ∈ {Ω}_{i}} I ( j ) K ( i , j ) g ( I ( i ) , I ( j ) ) ,$$

where I and y are the input and output images respectively, i is the target pixel and j is a pixel in the symmetric neighborhood of i denoted by Ωᵢ, K(i, j) relates to first domain and g(I(i), I(j)) relates to a second domain independent of said first domain; representing the bilateral filter as a first approximate bilateral filter (ABLF) defined as

$$y ( i ) = \frac{1}{{\sum }_{j} g ( f ( j ) - f ( i ) ) K ( j - i )} {\sum }_{j} f ( j ) g ( f ( j ) - f ( i ) ) K ( j - i ) ,$$

where f(i) is the signal point to be replaced by its filtered value y(i), j is an index over the neighborhood of the center point i, K(.) is the spatial linear filter, and g(.) is the range or photometric filter; defining a second approximate bilateral filter (ABLF) based on said first ABLF, said second ABLF being defined as: log(y₀)=log(2−ΣgⱼKⱼ)+log (ΣKⱼfⱼ)+log(ΣKⱼgⱼ) where y(i) [symbol] y₀, f(i) [symbol] f₀, f(j) [symbol] fⱼ, fⱼ−f₀ [symbol] Δfⱼ, g(Δfⱼ) [symbol] gⱼ, and K(j−i) [symbol] Kⱼ; and applying the results of said second approximate bilateral filter in place of said bilateral filter.

In this approach, K(i, j) is a spatial filter component and g(I(i),I(j)) is a featur filter component of said image. Preferably, the first domain is the spatial domain and measures the spatial affinity between pixels at i and j, and the second domain relates to a feature domain denoting feature, measurement, or photometric affinity.

Also in this approach, all correction terms resulting from an application of a Jensen's inequality transformation are ignored, i.e. discarded.

The present invention also provides an embodiment of a method of defining a fast approximat bilateral filter (a FABL filter) from a true bilateral filter, including: a processor to implement the following step: representing the bilateral filter as an approximate bilateral filter ABLF defined by

$$y ( i ) = \frac{1}{{\sum }_{j} g ( f ( j ) - f ( i ) ) K ( j - i )} {\sum }_{j} f ( j ) g ( f ( j ) - f ( i ) ) K ( j - i )$$

where f(i) is the signal point to be replaced by its filtered value y(i), j is an index over the neighborhood of the center point i, K(.) is a spatial linear filter, and g(.) is a range or photometric filter; using a Taylor series expansion to represent said ABLF as y₀=(2−ΣgⱼKⱼ)ΣfⱼgⱼKⱼ, where the following substitution are made: y(i) [symbol] y₀, f(i) [symbol] f₀, f(j) [symbol] fⱼ, fⱼ−f₀ [symbol] Δfⱼ, g(Δfⱼ) [symbol] gⱼ, and K(j−i) [symbol] Kⱼ, and where the summation always goes over a neighbor hood induced by location i; applying the Jensen's inequality transformation to ΣfⱼgⱼKⱼ, collecting any resulting errors into a first correction term C₁(f,g,K); and taking the log of result to obtain ΣKⱼ log(fⱼ)+ΣKⱼ log(gⱼ)+C₁(f,g,K); applying the Jensen's inequality transformation to ΣKⱼ log(fⱼ) and collecting any resulting errors into a second correction term C₂ (f,K) to define ΣKⱼ log(fⱼ)=log(ΣKⱼfⱼ)−C₂ (f,K); applyng the Jension's inequality transform to ΣKⱼ log(gⱼ) and collecting any resulting errors into a third correction term C₃(g,K) to define ΣKⱼ log(gⱼ)=log(ΣKⱼgⱼ)−C₃(g,K); taking the log of both sides of y₀=(2−ΣgⱼKⱼ)ΣfⱼgⱼKⱼ and omitting error terms C₁(f,g,K), −C₂(f,K), and −C₃(g,K) from the result to define the fast approximat bilateral filter as log(y₀)=log(2−ΣgⱼKⱼ)+log(ΣKⱼfⱼ)+log(ΣKⱼgⱼ).

In the present approach, the Taylor series expansion representation of the ABLF, K is pre normalized such that ΣKⱼ=1.

Also in the present approach, the neighborhood is 10 pixels in each direction; up, down, left and right.

Additionally, lookup tables may be used to determined a value of ΣKⱼ log(gⱼ).

Other objects and attainments together with a fuller understanding of the invention will become apparent and appreciated by referring to the following description and claims taken in conjunction with the accompanying drawings.

### BRIEF DESCRIPTION OF THE DRAWINGS

In the drawings wherein like reference symbols refer to like parts.

FIG. 1 illustrates the presently preferred method of constructing a fast approximate bilater filter.

FIG. 2a shows the results of applying a full bilateral filter to an image.

FIG. 2b shows the results of applying the presently preferred fast approximate bilateral filter to the same image as used in FIG. 2a, with parameters σᵣ²=0.1, σₛ²=1, r=21.

FIG. 3 uses a grayscale to illustrate the intensity difference between the image of FIG. 2a and the image of FIG. 2b.

FIG. 4 illustrates the time savings achieved by the present fast approximate BL over the full BL filter.

FIG. 5 shows a pixel neighborhood around center point i.

### DESCRIPTION OF THE PREFERRED EMBODIMENTS

Because of the need for combining information from two domains, bilateral filters may require more time than other filters. Efforts to speed up the processing of bilateral filters have lead to the development of the approximate bilateral filter (ABLF), which is typically much than the basic bilateral filter (BLF). The present invention provides a new, fast approximate bilateral filter.

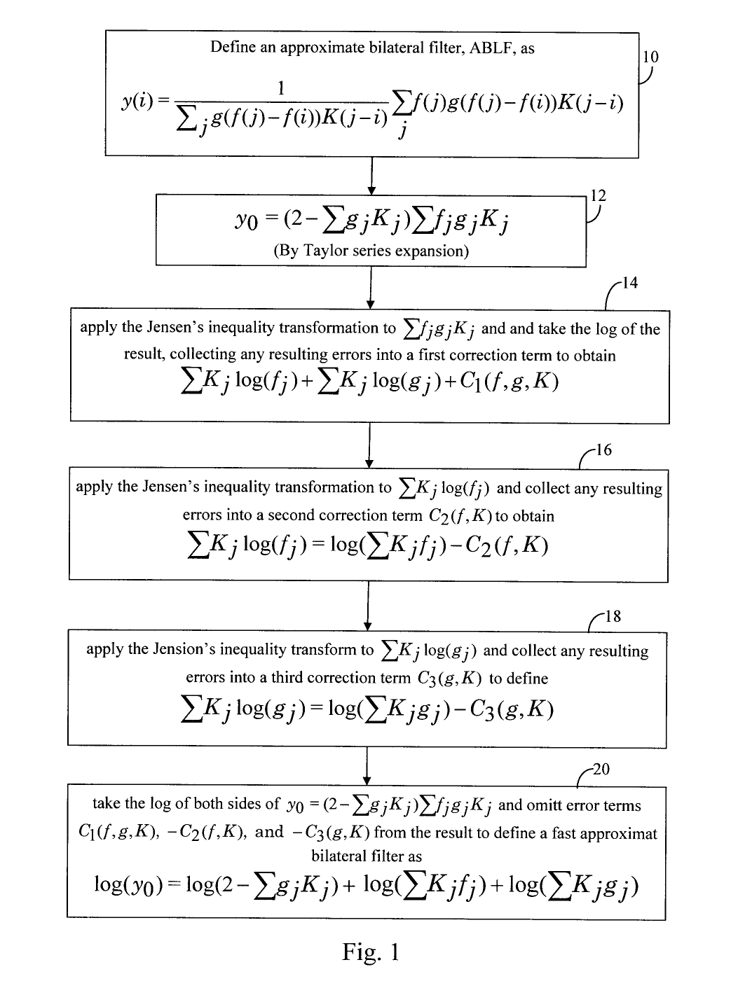

With reference to FIG. 1, an approximate bilateral filter may be represented as shown in equation (1), step 10:

$$y ( i ) = \frac{1}{{\sum }_{j} g ( f ( j ) - f ( i ) ) K ( j - i )} {\sum }_{j} f ( j ) g ( f ( j ) - f ( i ) ) K ( j - i ) \qquad ( 1 )$$

where f(i) is the signal point to be replaced by its filtered value y(i). j is an index over the neighborhood of the center point i. As shown in FIG. 5, this neighborhood is preferably 10 pixels in each direction from i, such that the neighborhood forms a parallelogram with i at its center and extending 10 pixels up from i, 10 pixels down from i, 10 pixels left from i, and 10 pixels right from i. K(.) is the spatial linear filter, and g(.) is the range or photometric filter. To simplify explanation of the present invention, and to remove any unintended ambiguity, the following discussion will use a simplified notation, wherein, the reference is fixed at the location i, and the variables are renamed a follows:

f(i) [symbol] f₀

f(j) [symbol] fⱼ

fⱼ−f₀ [symbol] Δfⱼ

g(Δfⱼ) [symbol] gⱼ

K(j−i) [symbol] Kⱼ

Using the above, simplified notation, equation (1) may be rewritten as equation (2), below.

$${y}_{0} = \frac{1}{{\sum }_{j} {g}_{j} {K}_{j}} {\sum }_{j} {f}_{j} {g}_{j} {K}_{j} \qquad ( 2 )$$

Preferably, filter K is pre normalized such that ΣKⱼ=1.

It has been shown that the normalization term in the denominator can be approximated by a Taylor series expansion. Using this Taylor series expansion, the filter of equation (2) can be further written, as shown in step 12, as

y₀=(2−ΣgⱼKⱼ)ΣfⱼgⱼKⱼ (3)

where index j is dropped from the summation for simplicity. In the following discussion, it is assumed that the summation always goes over the neighbor hood induced by location i.

Lookup tables may be used with equation (3) for all possible values of g and K, thereby reducing the run-time for filtering.

The presently preferred method further reduces the CPU cycle by a introducing an additional approximation. Looking at the last factor in Eqn. (3), i.e. the right term, RT, can be modified as follows:

$$RT ≐ \sum {f}_{j} {g}_{j} {K}_{j} = \frac{\sum ( {f}_{j} {g}_{j} ) {K}_{j}}{\sum {K}_{j}} \geq \prod {( {f}_{j} {g}_{j} )}^{\frac{{K}_{j}}{\sum {K}_{j}}} = \prod {( {f}_{j} {g}_{j} )}^{{K}_{j}}$$

Here, the mathematical transformation known as Jensen's inequality is used to switch from the equality to the inequality. As is known, Jensen's inequality transformation introduces discrepancies, or errors. If these discprencies are collected into a first correction term C₁(f,g,K), and the logarithm of both sides is taken as shown step 14, the result is equation (4).

log RT=ΣKⱼ log(fⱼ)+ΣKⱼ log(gⱼ)+C₁(f,g,K) (4)

Equation (4) can be exploited in multiple ways. Firstly, the term ΣKⱼ log(gⱼ) can be obtained by a lookup, and the first term on the RHS, ΣKⱼ log(fⱼ), is a convolution of the log of the image with the kernel K. As shown in step 16, one can use Jensen's inequality again to write

ΣKⱼ log(fⱼ)≦log(ΣKⱼfⱼ)

ΣKⱼ log(fⱼ)=log(ΣKⱼfⱼ)−C₂(f,K)

Similarly, step 18 applies Jensen's inequality to term ΣKⱼ log(gⱼ) to obtain:

ΣKⱼ log(gⱼ)≦log(ΣKⱼgⱼ)

ΣKⱼ log(gⱼ)=log(ΣKⱼgⱼ)−C₃(g,K)

Combining the above results, equation (4) can be rewritten as

log RT=log(ΣKⱼfⱼ)+log(ΣKⱼgⱼ)+C₁(f,g,K)−C₂(f,K)−C₃(g,K) (5)

Returning to filter equation (3), and taking the log of both sides one gets

log(y₀)=log(2−ΣgⱼKⱼ)+log(ΣfⱼgⱼKⱼ) (6)

Recalling that log(ΣfⱼgⱼKⱼ)=log RT, combining equations (5) and (6), and removing the correction terms, as indicated in step 20, one gets the final expression for the present fast approximate bilateral filter (i.e. FABL Filter) as

log(y₀)=log(2−ΣgⱼKⱼ)+log(ΣKⱼfⱼ)+log(ΣKⱼgⱼ) (7)

This form decouples the bilateral filter into multple linear filtering operations and hence represents a step towards faster implementations of the filter. The next step is to address the correction terms that were omitted.

Given the formulation of equation (7), one proceeds in the direction of identifying range g and spatial K filter pairs that reduce the approximation error. Another direction to investigate would be to incorporate the contribution of the error terms into the filter response. This is possible, if the constant terms behave deterministically for edge and non-edge regions within some reasonable kernel size. For generic bilateral filters both range and spatial filters are assumed to be Gaussian kernels with σₛ>>σᵣ, where σₛ represents the variance of the spatial kernel K and σᵣ represents the variance of the range kernel g. The other parameter, which is specified for such filters, is the size of the two kernels, and is denoted by r (both K and g have the same support size).

It is known from the theory of maximum entropy, that the Jensen approximation error is minimum when the probability of the independent variables is exactly equal to one another. Extending the same reasoning for uniform texture regions with noise (σ<<σᵣ), the Jensen approximation error is almost negligible and hence the magnitudes of the error constants C₁ [symbol] 0, C₂ [symbol] 0, C₃ [symbol] 0. Furthermore, C₁ [symbol] C₂+C₃. Hence the response for the approximate filter closely matches the ideal bilateral filter for uniform texture regions.

One next needs to examine how the present approximation filter behaves in the case of non-uniform texture regions, more commonly known as edge regions. The idea is that the more non-uniform the data is the higher is the entropy. Now, if the kernel g smooths out the data f, then the term fⱼgⱼ is smoother than the term fⱼ. This transformation can be thought of as a bandlimited form of the Weierstrass transform, and it leads to the conclusion that C₁<C₂+C₃ for an edge patch. Therefore, dropping correction terms C₁−C₂−C₃ from equation (5) in creating equation (7) essentially means adding the positive quantity |C₂+C₃−C₁| to the edge region response. The net effect being that the approximation boosts edge regions, which is a desirable effect. So in principle, the approximation filter of equation (7) leads to good bilateral behavior.

The following is a more detail analysis of the presently preferred approximate bilateral filter in accord with the present invention.

For a uniform texture region, it is assumed that the current patch is centered at f₀. It is also assumed that all the intensities are normalized to lie in the range (0,1). It is further assumed that the intensity values

fⱼ˜ [symbol] (f₀,σ)∀jεΓ₀

where [symbol] represents the Gaussian normal distribution with mean f₀ and variance σ, and where Γ₀ is the square neighborhood induced by the location of the pixel f₀ and σ<<σᵣ. Under these assumptions,

$$\sum ( {f}_{j} {e}^{- \frac{{( Δ {f}_{j} )}^{2}}{2 ( {σ}_{r}^{2} + {σ}^{2} )}} ) {K}_{j} \geq \prod ( {f}_{j} {e}^{- \frac{{( Δ {f}_{j} )}^{2}}{2 ( {σ}_{r}^{2} + {σ}^{2} )}} ) {K}_{j} \\ ⇓ \\ \sum ( {f}_{j} {K}_{j} ) \geq \prod {( {f}_{j} )}^{{K}_{j}} \\ ⇓ \\ {C}_{1} \approx {C}_{2}$$

Now assuming that the patch contains a dominant edge, and the intensity values are drawn from a mixture of Gaussians, then

fⱼ˜αN(f₀,σ₀)+(1-α)N(μ,σ₁)∀jεΓ₀

This model assumes that edge and non-edge pixels are drawn from 2 different Gaussian distributions, and the center pixel f₀ is the mean of one of them. For reasonably small patches, one can relax this assumption and write

$${f}_{j} ∼ \{ \begin{matrix}N ( {f}_{0} , σ ) \\ N ( μ , σ )\end{matrix}$$

Now the pixels in the patch are divided into two sets, one set is similar to the central pixel f₀ and the other set contains the remaining pixels.

$${\sum }_{sim} ( {f}_{i} {e}^{- \frac{{( Δ {f}_{j} )}^{2}}{2 ( {σ}_{r}^{2} + {σ}^{2} )}} ) {K}_{i} + {\sum }_{rem} ( {f}_{j} {e}^{- \frac{{( μ - {f}_{0} )}^{2}}{2 ( {σ}_{r}^{2} + {σ}^{2} )}} ) {K}_{j} \geq {\prod }_{sim} ( {f}_{i} {e}^{- \frac{{( Δ {f}_{j} )}^{2}}{2 ( {σ}_{r}^{2} + {σ}^{2} )}} ) {K}_{i} {\prod }_{rem} ( {f}_{j} {e}^{- \frac{{( μ - {f}_{0} )}^{2}}{2 ( {σ}_{r}^{2} + {σ}^{2} )}} ) {K}_{j}$$

$${\sum }_{sim} ( {f}_{i} {K}_{i} ) + {\sum }_{rem} ( {f}_{j} {e}^{- \frac{{( μ - {f}_{0} )}^{2}}{2 ( {σ}_{r}^{2} + {σ}^{2} )}} ) {K}_{j} \geq {\prod }_{sim} {( {f}_{i} )}^{{K}_{i}} {\prod }_{rem} ( {f}_{j} {e}^{- \frac{{( μ - {f}_{0} )}^{2}}{2 ( {σ}_{r}^{2} + {σ}^{2} )}} ) {K}_{j}$$

Now equating the approximation errors, one can write

$${C}_{1} = {\sum }_{sim} {K}_{i} log {f}_{i} + {\sum }_{rem} {K}_{j} log {f}_{j} - {K}_{j} {\sum }_{rem} \frac{{( μ - {f}_{0} )}^{2}}{2 ( {σ}_{r}^{2} + {σ}^{2} )}$$

$${C}_{1} = {C}_{2} - {K}_{j} {\sum }_{rem} \frac{{( μ - {f}_{0} )}^{2}}{2 ( {σ}_{r}^{2} + {σ}^{2} )}$$

Thus the edge regions are boosted by a factor

$${K}_{j} {\sum }_{rem} \frac{{( μ - {f}_{0} )}^{2}}{2 ( {σ}_{r}^{2} + {σ}^{2} )}$$

This confirms the basic trait of the present approximation, wherein the edge regions are boosted and the flat regions essentially remain the same. In the next section, experiments that exemplify these features are presented.

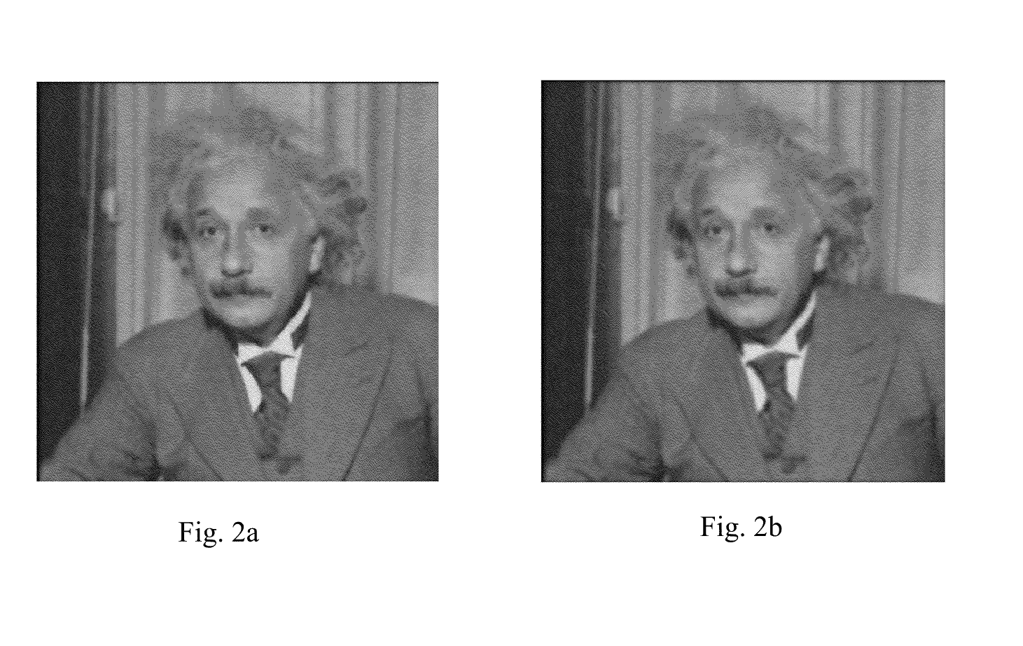

FIG. 2a shows the results of applying a full bilateral filter to an image. FIG. 2b shows the results of applying the present fast approximate bilateral filter to the same image, with parameters σᵣ²=0.1, σₛ²=1, r=21.

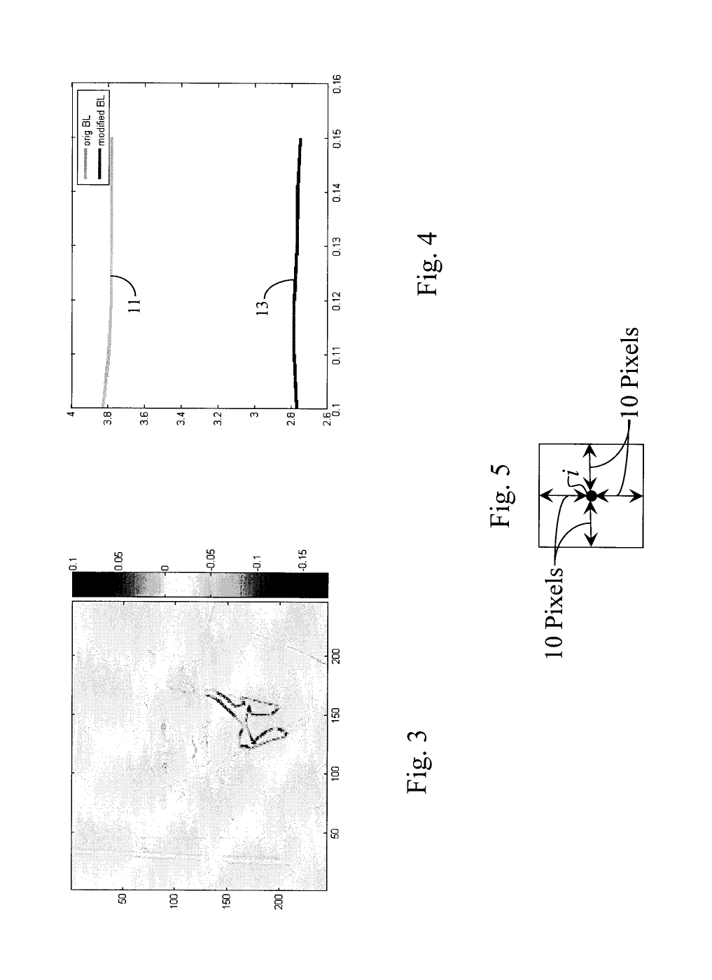

FIG. 3 uses a grayscale to illustrate the intensity difference between the image of FIG. 2a (created with the full BL filter) and the image of FIG. 2b (created with the present approximate fast BL). As shown, the majority of the image shows very little intensity difference. Intensity differences are notable primarily only in the border areas of the white shirt, and even in these areas, the intensity difference remains predominantly between +/−0.1.

FIG. 4 illustrates the time savings achieved by the present fast approximate BL over the full BL filter. The graph shows the execution time along the vertical for a given range varience σᵣ², while maintaining parameter σₛ² and r fixed at σₛ²=1 and r=21. As shown, the present approximte fast BL, indicated by line 13, is consistantly about 30% faster than the full BL filster, indicated by line 11.

While the invention has been described in conjunction with several specific embodiments, it is evident to those skilled in the art that many further alternatives, modifications and variations will be apparent in light of the foregoing description. Thus, the invention described herein is intended to embrace all such alternatives, modifications, applications and variations as may fall within the spirit and scope of the appended claims.

What is claimed is:

1. A method of implementing a bilateral filter, comprising:
providing a data processor to implement the following steps:
defining said bilateral filter as
$$y ( i ) = \frac{1}{Z ( i )} {\sum }_{j ∈ {Ω}_{i}} I ( j ) K ( i , j ) g ( I ( i ) , I ( j ) ) ,$$
where I and y are the input and output images respectively, i is the target pixel and j is a pixel in the symmetric neighborhood of i denoted by Ωᵢ, K (i, j) relates to first domain and g(I(i), I(j)) relates to a second domain independent of said first domain;
representing said bilateral filter as a first approximate bilateral filter (ABLF) defined as
$$y ( i ) = \frac{1}{{\sum }_{j} g ( f ( j ) - f ( i ) ) K ( j - i )} {\sum }_{j} f ( j ) g ( f ( j ) - f ( i ) ) K ( j - i ) ,$$
where f(i) is the signal point to be replaced by its filtered value y(i), j is an index over the neighborhood of the center point i, K(.) is the spatial linear filter, and g(.) is the range or photometric filter;
defining a second approximate bilateral filter (ABLF) based on said first ABLF, said second ABLF being defined as:
log(y₀)=log(2−ΣgⱼKⱼ)+log(ΣKⱼfⱼ)+log(ΣKⱼgⱼ)
where y(i) [symbol] y₀, f(i) [symbol] f₀, f(j) [symbol] fⱼ, fⱼ−f₀ [symbol] Δfⱼ, g(Δf) [symbol] gⱼ, and K (j−i) [symbol] Kⱼ; and
applying the results of said second approximte bilateral filter in place of said bilatera filter.

2. The method of claim 1, wherein K(i, j) is a spatial filter component and g(I(i), I(j)) is a featur filter component of said image.

3. The method of claim 1, wherein said first domain is the spatial domain and measures the spatial affinity between pixels at i and j, and said second domain relates to a feature domain denoting feature, measurement, or photometric affinity.

4. The method of claim 1, wherein all correction terms resulting from an application of a Jensen's inequality transformation are ignored, i.e. discarded.

5. A method of defining a fast approximat bilateral filter (a FABL filter) from a true bilateral filter, comprising:
a processor to implement the following step:
representing said bilateral filter as an approximate bilateral filter ABLF defined by
$$y ( i ) = \frac{1}{{\sum }_{j} g ( f ( j ) - f ( i ) ) K ( j - i )} {\sum }_{j} f ( j ) g ( f ( j ) - f ( i ) ) K ( j - i )$$
where f(i) is the signal point to be replaced by its filtered value y(i), j is an index over the neighborhood of the center point i, K(.) is a spatial linear filter, and g(.) is a range or photometric filter;
using a Taylor series expansion to represent said ABLF as y₀=(2−ΣgⱼKⱼ)ΣfⱼgⱼKⱼ, where the following substitution are made: y(i) [symbol] y₀, f(i) [symbol] f₀, f(j) [symbol] fⱼ, fⱼ−f₀ [symbol] Δfⱼ, g(Δfⱼ) [symbol] gⱼ, and K(j−i) [symbol] Kⱼ, and where the summation always goes over a neighbor hood induced by location i;
applying the Jensen's inequality transformation to ΣfⱼgⱼKⱼ, collecting any resulting errors into a first correction term C₁(f,g,K); and taking the log of result to obtain ΣKⱼ log(fⱼ)+ΣKⱼ log(gⱼ)+C₁(f,g,K);
applying the Jensen's inequality transformation to ΣKⱼ log(fⱼ) and collecting any resulting errors into a second correction term C₂(f,K) to define ΣKⱼ log(fⱼ)=log(ΣKⱼfⱼ)−C₂ (f,K);
applyng the Jension's inequality transform to ΣKⱼ log(gⱼ) and collecting any resulting errors into a third correction term C₃(g,K) to define ΣKⱼ log(gⱼ)=log(ΣKⱼgⱼ)−C₃ (g,K);
taking the log of both sides of y₀=(2−ΣgⱼKⱼ)ΣfⱼgⱼKⱼ and omitting error terms C₁(f,g,K), −C₂(f,K), and −C₃(g,K) from the result to define said fast approximat bilateral filter as log(y₀)=log(2−lⱼgⱼKⱼ)+log(ΣKⱼfⱼ)+log(ΣKⱼgⱼ).

6. The method of claim 5, wherein in the Taylor series expansion representation of said ABLF, K is pre normalized such that ΣKⱼ=1.

7. The method of claim 5, wherein said neighborhood is 10 pixels in each direction; up, down, left and right.

8. The method of claim 5, wherein lookup tables are used to determined a value of ΣKⱼ log(gⱼ).
